(19) United States
(12) Patent Application Publication
(10) Pub. No.: US 2023/0068293 A1
(43) Pub. Date: Mar. 2, 2023

(54) SYSTEM AND METHOD FOR DETECTING REPUTATION ATTACKS

(71) Applicant: TRUST LTD., Moscow (RU)

(72) Inventor: Igor NEZHDANOV, Lubertsy (RU)

(21) Appl. No.: 17/724,544

(22) Filed: Apr. 20, 2022

(30) Foreign Application Priority Data
Aug. 27, 2021 (RU) 2021125359

(51) Int. Cl. G06F 21/55

(52) U.S. Cl. CPC G06F 21/554; G06F 2221/034

(57) ABSTRACT

A method and a system for detecting reputation attacks. The method comprises: identifying a plurality of publication sources; determining, in the plurality of publication sources, suspicious publication sources used for execution of reputation cyberattacks in the network; identifying, in each of the suspicious publication sources, suspicious user accounts having posted the suspicious publications; determining, among the suspicious user accounts, bot user accounts; and storing, data of the suspicious publication sources and that of the bot user accounts having posted the suspicious publications thereon in a database; obtaining at least one word representing an object of a potential reputation cyberattack; identifying, based on the at least one word, in-use publications; determining, based on the data in the database, in-use statistics for the in-use publications, in response to at least one of the in-use statistics exceeding a respective threshold, determining a given reputation attack targeting the object.

### CROSS-REFERENCE

The present application claims priority to a Russian Patent application No.: 2021125359, filed on Aug. 27, 2021, and entitled “SYSTEM AND METHOD FOR DETECTING REPUTATION ATTACKS”, the content of which is incorporated herein by reference in its entirety.

### FIELD

The present technology relates broadly field of cybersecurity; and, in particular, to systems and methods for detecting reputation attacks.

### BACKGROUND

As used hereinbelow, a reputation attack is a method of influencing public opinion, carried out by posting information in open Internet sources, such as text articles, for example, discrediting the reputation of the object of attack. In other words, the purpose of the reputation attack is to form a negative attitude of the audience towards the object of attack, through placement of specific publications on the Internet.

An object of the reputation attack may include, for example, an individual, an organization, a construction project (such as the Crimean bridge, for example), brand name (such as Adidas™ or Pyaterochka™), a territory or country; an event or activity (such as the Scarlet Sails Graduation Party held in Saint-Petersburg), a technology or product (such as a Sputnik V™ vaccine or an Angara space rocket, as an example).

There is a number of ways of influencing public opinion, and in particular, ways of worsening or improving someone's reputation. However, the advent and development of the global Internet as a means of mass communications has given rise to a whole layer of new methods and techniques for manipulating the public opinion. Pursuing various goals, these manipulation methods, however, are constantly becoming more and more complex, which may thus require new approaches for their detection.

Certain prior art approaches have been proposed to tackle the problem of detecting the reputation attacks.

An article “REPULSE OF INFORMATION ATTACK: ALGORITHM OF ACTIONS” authored by D. Shubenok, I. Ashmanov, and published on May 28, 2018 at ashmanov.com/education/articles/otrazhenie-informatsionnoy-ataki-algoritm-deystviy/discloses tools that could be used for reputation attacks. Besides, this publication contains a specification of a possible scenarios of an online reputation attack including a massive number of user accounts typically controlled by specific programs, such as bots.

Russian Patent No.: 2,656,583-C1 issued on Jun. 5, 2018, assigned to JSC “Kribrum”, and entitled “SYSTEM OF COMPUTER AIDED ANALYSIS OF FACTS” discloses a system for verifying and analyzing of social media user behavioral actions. The system includes a common data bus module for social media input data receiving, an identification module for the type of event made by the user, a module for the user identifying and the data they entered, a module for the identification of information associated with the data entered by the user, depending on the type of event, a module for identification of information about the user's skills in the user-entered data and information associated with the user-entered data, a user profile module that associates information characterizing the user's skills with the profile of the identified user, an information processing module configured to, based on user input, information associated with user inputted data, user profile information that identifies the user, his skills, prescribe a certain level of threat to user actions, a displaying information module to display user profiles and their threat level.

U.S. Pat. No. 8,527,596-B2, published on Sep. 3, 2013, assigned to Profile Protector LLC, entitled “SYSTEM AND METHOD FOR MONITORING ACTIVITY OF A SPECIFIED USER ON INTERNET-BASED SOCIAL NETWORKS” discloses a system and method are provided for monitoring activity on an internet-based social network. Monitoring criteria is pre-established by a client for monitoring activity on a specified user's page of the social network. Activity monitoring access to the specified user's page of the internet-based social network is established via an application programming interface of the social network based on pre-established identification information that identifies the specified user within the internet-based social network. The client is notified when the monitored activity satisfies at least one of the pre-established monitoring criteria.

### SUMMARY

It is an object of the present technology to ameliorate at least inconveniences associated with the prior art.

Unlike the prior art approaches, non-limiting embodiments of the present technology are directed to identifying reputation attacks and notifying entities associated with the objects of such attacks for taking remedial actions in a timely manner.

More specifically, in accordance with a first broad aspect of the present technology, there is provided a method for detecting reputation cyberattacks in a network. The method is executable by a computing device including a processor communicatively coupled to the network. The method comprises, during a first phase: crawling, by the processor, the network to identify a plurality of publication sources; identifying, in the plurality of publication sources, suspicious publication sources having been used for posting suspicious publications, the suspicious publications for executing reputation cyberattacks in the network; identifying, by the processor, in each of the suspicious publication sources, suspicious user accounts having posted the suspicious publications; determining, by the processor, among the suspicious user accounts, bot user accounts; and storing, by the processor, data of the suspicious publication sources and that of the bot user accounts having posted the suspicious publications thereon in a database. Further, during a second phase following the first phase: the method comprises: obtaining, by the processor, at least one word representing an object of a potential reputation cyberattack; crawling, by the processor, the network to identify in-use publications including the at least one word associated with the object of the potential reputation attack; determining, by the processor, based on the data in the database, in-use statistics associated with the in-use publications, the in-use statistics being indicative of at least one of: (i) quantitative characteristics associated with the in-use publications and (ii) how the quantitative characteristics change over time; in response to at least one of the in-use statistics exceeding a respective predetermined threshold value, determining, by the processor, (i) a given reputation attack targeting the object; and (ii) a respective type of the given reputation attack; and generating, by the processor, a notification of the given reputation attack including the respective type thereof for transmission of the notification to an entity associated with the object.

In some implementations of the method, the suspicious publication sources include at least one of:
compromising material aggregators,
social networks,
data leak aggregators,
advertising platforms,
groups of related sources,
user feedback aggregators, and
sites for hiring remote workers.

In some implementations of the method, the groups of related sources include publication sources that have identical publications, the identical publications having been posted more than a threshold number of times, with a publication time difference therebetween not exceeding a threshold time difference value.

In some implementations of the method, the bot user accounts include user accounts that make at least a predetermined number of publications within a predetermined period.

In some implementations of the method, the bot user accounts further include the user accounts that make publications with a frequency exceeding a threshold frequency value over the predetermined period.

In some implementations of the method, the quantitative characteristics associated with the in-use publications include at least one of:
a total number of the in-use publications,
a number of in-use publications posted by the bot user accounts,
a number of in-use publications made on compromising material aggregators,
a number of in-use publications made by groups of related publication sources,
a number of in-use publications made by suspicious publication sources that are classified as being both groups of related sources and compromising material aggregators,
a number of in-use publications made on advertising platforms,
a number of in-use publications made on advertising platforms that form part of at least one group of related sources,
a number of in-use publications made on user feedback aggregators,
a number of in-use publications made on data leak aggregators,
a number of in-use publications made on web resources for hiring remote workers,
a total number of in-use publications duplicating each other,
a total number of in-use publications on compromising material aggregators duplicating each other,
a total number of in-use publications on compromising material aggregators duplicating each other and made by the bot user accounts,
a respective total number of hyperlinks in a given in-use publication,
a respective total number of hyperlinks in a given in-use publications that has duplicates,
a number of user accounts from which in-use publications have been posted,
a number of the bot user accounts from which the in-use publications have been posted,
a number of user accounts from which in-use publications have been posted on the compromising material aggregators, and
a number of user accounts, controlled by bots, from which the publications are posted on compromising material aggregators, and
number of accounts from which the publications identified on advertising platforms are posted.

In some implementations of the method, the in-use statistics further include dynamic changes thereof at a plurality of predetermined moments in time over a predetermined time interval.

In some implementations of the method, for the at least one in-use statistic, the respective predetermined threshold is expressed in at least one of absolute and relative units.

In some implementations of the method, the transmission of the notification to the entity associated with the object is executed by at least one of:
an e-mail,
an SMS,
an MMS,
push notifications,
instant messenger messages, and
API events.

In some implementations of the method, the respective type of the given reputation attack is assigned with a numerical value indicative of a severity level of the given reputation attack.

In some implementations of the method, the severity level includes at least one of “Warning”, “Threat”, and “Attack”.

In accordance with a second broad aspect of the present technology, there is provided a system for detecting reputation cyberattacks in a network, the system comprising a computing device. The computing device includes: (i) a processor communicatively coupled to the network, and (ii) a non-transitory computer-readable memory storing instructions. The processor, upon executing the instructions, during a first phase, is configured to: crawl the network to identify a plurality of publication sources; identify, in the plurality of publication sources, suspicious publication sources having been used for posting suspicious publications, the suspicious publications for executing reputation cyberattacks in the network; identify, in each of the suspicious publication sources, suspicious user accounts having posted the suspicious publications; determine, among the suspicious user accounts, bot user accounts; and store data of the suspicious publication sources and that of the bot user accounts having posted the suspicious publications thereon in a database. Further, during a second phase following the first phase, the processor is configured to: obtain at least one word representing an object of a potential reputation cyberattack; crawl the network to identify in-use publications including the at least one word associated with the object of the potential reputation attack; determine, based on the data in the database, in-use statistics associated with the in-use publications, the in-use statistics being indicative of at least one of: (i) quantitative characteristics associated with the in-use publications and (ii) how the quantitative characteristics change over time; in response to at least one of the in-use statistics exceeding a respective predetermined threshold value, determine (i) a given reputation attack targeting the object; and (ii) a respective type of the given reputation attack; and generate a notification of the given reputation attack including the respective type thereof for transmission of the notification to an entity associated with the object.

Certain terms used in the present specification are defined in the context thereof as set forth below.

An account at a given we resource denotes a unique user account, which creation is a necessary and sufficient condition for a specific user to participate in communications through the given web resource, such as a social network. The account can include unique user data identifying the user thereof, including, for example: a username, its sequence number or other combination of characters.

A social network is an Internet platform that allows the registered (having respective accounts thereof) users to communicate with each other. The content on such a web resource is created, at least in part, by the users themselves. In terms of the user interface, the social network could be implemented as a website, such as vk.com, facebook.com, or as an instant or Internet messenger, such as Telegram or Discord.

A source of publications (or simply a “source” for short) is a website or community (channel, group, server) on a social network that specializes in posting publications, such as those in a text format. Within the context of this specification, the sources non-exhaustively include:
mass media, on which websites there could be both publications as such and comments under the publications;
forums;
blogs of journalists, politicians and public figures;
communities (groups, publics) on social networks;
video hosting services and stream servers;
question and answer services;
sign-in services;
crowdfunding services;
websites performing the following functions:
   a. user feedback aggregators,
   b. rating agencies;
   c. “bulleting boards”, including:
      i. account exchanges,
      ii. sites for hiring remote workers.

A bulleting board is a web resource providing services for posting advertisements on various topics.

An account exchange is a type of bulletin board allowing posting offers for sale, lease, or purchase of accounts owned by human users or bots.

A bot denotes an account controlled by a program that is configured, for example, to leave messages on behalf of one of human users of a given social network. Usually, after an initial setup, the bot acts autonomously and posts specific content messages on the given social network without operator's participation.

A group of related sources denotes a group of sources, where publications, such as texts, are posted by one person or an organized group of people.

A compromising material aggregator denotes a web resource that posts publications only on compromising material nature. An example of such a resource is the compromat.ru website.

A data leaks aggregator is a resource that posts publications, such as texts, only on data leak (insider) nature. An example of such a source is the WikiLeaks website.

A rating agency denotes a web resource configured to form and display ratings of certain web resources. For example, ratings of the most influential user feedback aggregators, ratings of account exchanges, ratings of SMM service exchanges, etc.

An advertising platform denotes a web resource that is a mass media outlet that are configured to post advertisements mimicking news.

In the context of the present specification, unless expressly provided otherwise, a computer system may refer, but is not limited, to an “electronic device”, an “operation system”, a “system”, a “computer-based system”, a “controller unit”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

### BRIEF DESCRIPTION OF THE DRAWINGS

Non-limiting embodiments of the present technology are described herein with reference to the accompanying drawings; these drawings are only presented herein to explain the essence of the technology and are not intended to limit the scope thereof in any way, where:

FIG. 1A depicts a flowchart diagram of a first stage of a method of detecting reputation attacks in a communication network, in accordance with certain non-limiting embodiments of the present technology;

FIG. 1B depicts a flowchart diagram of a step of the first stage of FIG. 1A for identifying suspicious publications in the communication network, in accordance with certain non-limiting embodiments of the present technology;

FIG. 1C depicts a flowchart diagram of step of the first stage of FIG. 1A for identifying suspicious publications in the communication network, in accordance with other non-limiting embodiments of the present technology;

FIG. 1D depicts a flowchart diagram of step of the first stage of FIG. 1A for identifying suspicious user accounts from which the suspicious publications have been made in the communications network, in accordance with certain non-limiting embodiments of the present technology;

FIG. 2A depicts a flowchart diagram of a second stage of the method of detecting the reputation attacks in the communication network, in accordance with other non-limiting embodiments of the present technology;

FIGS. 2B and 2C depict flowchart diagrams of implementations of a step of the second stage of FIG. 2A for determining in-use statistics associated with the in-use publications, in accordance with other non-limiting embodiments of the present technology;

FIG. 3 depicts a flowchart diagram of a step of the second stage of FIG. 2A for determining a type of the reputation attack based on the in-use statistics determined at step of FIGS. 2B and 2C, in accordance with other non-limiting embodiments of the present technology; and

FIG. 4 depicts a schematic diagram of an example computing environment configurable for execution of the method of detecting the reputation attacks in the communication network, in accordance with certain non-limiting embodiments of the present technology.

### DETAILED DESCRIPTION

The following detailed description is provided to enable anyone skilled in the art to implement and use the non-limiting embodiments of the present technology. Specific details are provided merely for descriptive purposes and to give insights into the present technology, and in no way as a limitation. However, it would be apparent to a person skilled in the art that some of these specific details may not be necessary to implement certain non-limiting embodiments of the present technology. The descriptions of specific implementations are only provided as representative examples. Various modifications of these embodiments may become apparent to the person skilled in the art; the general principles defined in this document may be applied to other non-limiting embodiments and implementations without departing from the scope of the present technology.

Certain non-limiting embodiments of the present technology area directed to a system and method of detecting reputation attacks as set forth hereinbelow.

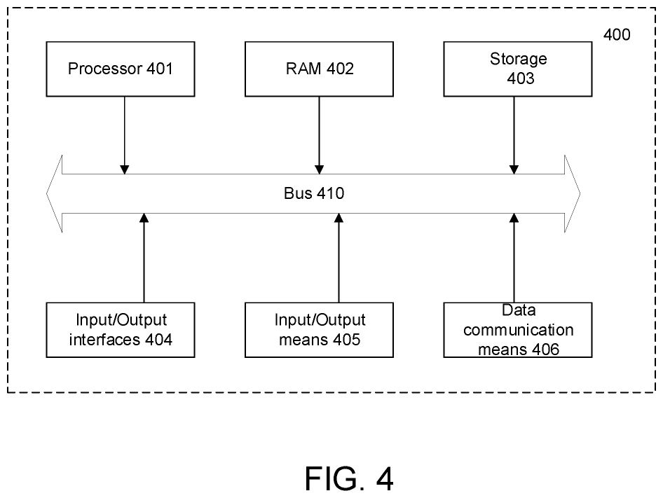

In accordance with certain non-limiting embodiments of the present technology, the system may comprise a computing device, which may further comprise, without limitation, a personal computer, a tablet, a smart phone, and the like. To that end, the computing device can include some or all components of a computing environment 400 described below with reference to FIG. 4.

According to certain non-limiting embodiments of the present technology, the computing device can be configured to couple to a communication network.

In some non-limiting embodiments of the present technology, the communication network is the Internet. In alternative non-limiting embodiments of the present technology, the communication network can be implemented as any suitable local area network (LAN), wide area network (WAN), a private communication network, or the like. It should be expressly understood that implementations for the communication network are for illustration purposes only. How a communication link (not separately numbered) between the computing device and the communication network is implemented will depend, inter alia, on how the computing device is implemented. Merely as an example and not as a limitation, in those embodiments of the present technology where the computing device is implemented as a wireless communication device such as the smartphone, the communication link can be implemented as a wireless communication link. Examples of wireless communication links include, but are not limited to, a 3G communication network link, a 4G communication network link, and the like.

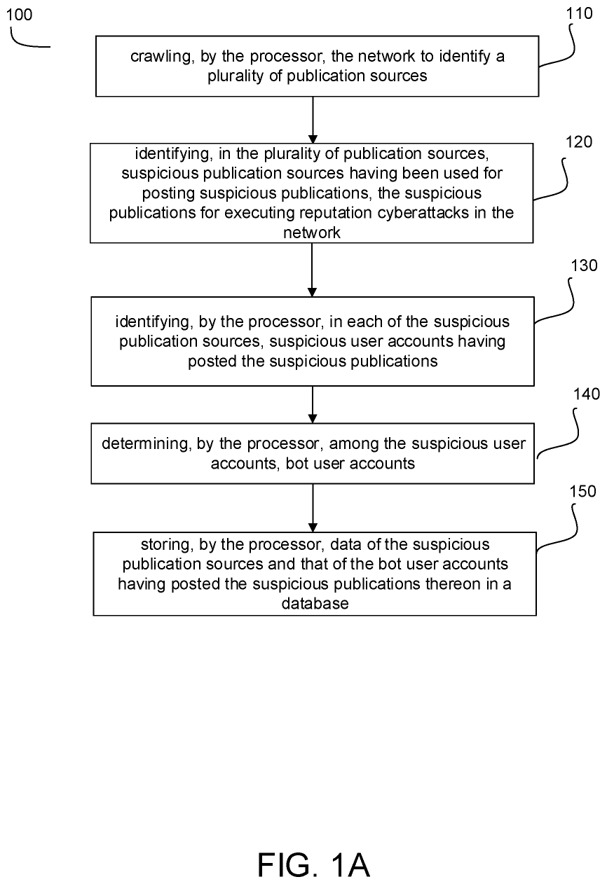

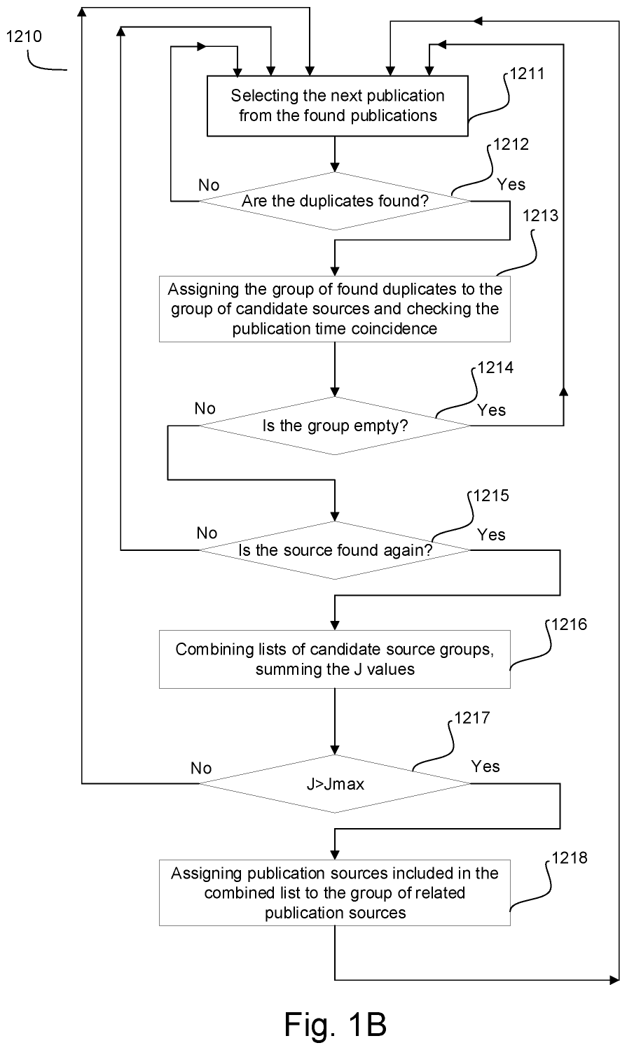

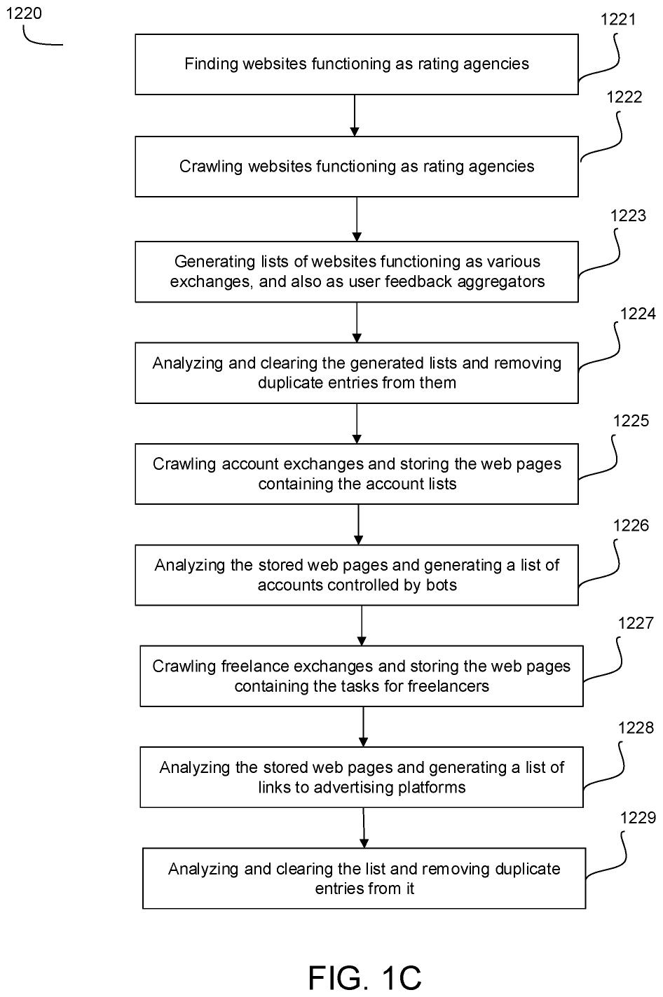

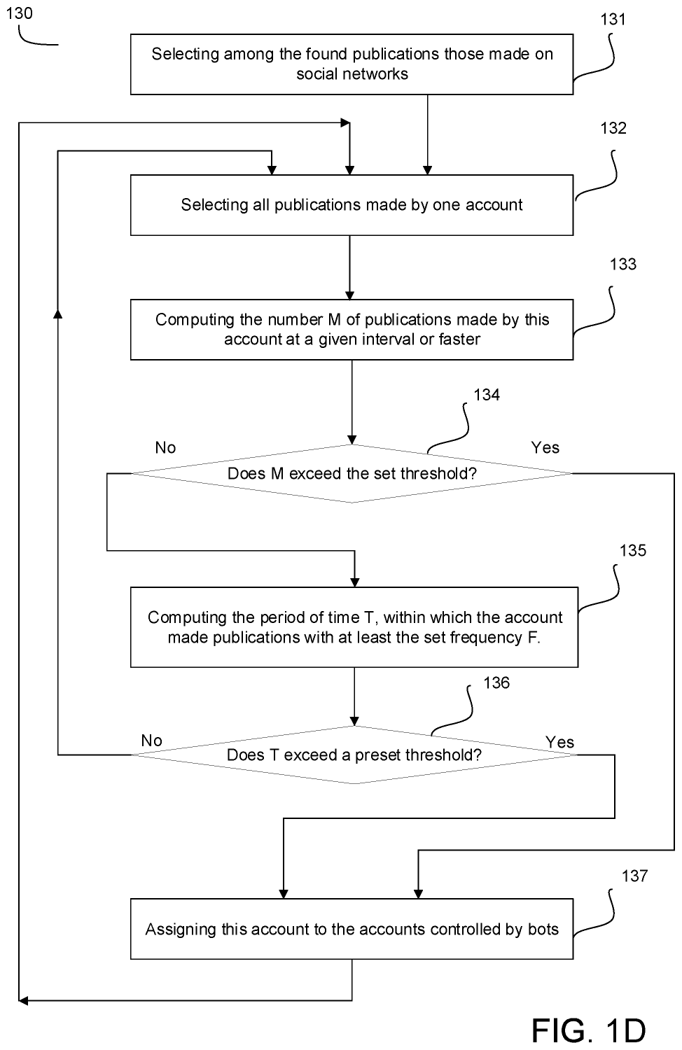

Further, according to certain non-limiting embodiments of the present technology, the present method of detecting the reputation attack may be executed, such as by a processor 401 of the computing device, in two stages. During a first stage, the processor 401 can be configured to generate, such as in a storage 503 of the computing device, a database including suspicious publication sources and suspicious user accounts conducting reputation attacks therein, as will be described in detail below with reference to FIGS. 1A to 1D. During a second stage following the first stage, the processor 401 can be configured to use the generated database to identify new reputation attacks, as will be described in detail below with reference 2A, 2B, 2C, and 3.

### Method

With reference to FIG. 1A, there is depicted a schematic diagram of a first stage 100 of the present method of detecting the reputation attacks in the communication network, in accordance with certain non-limiting embodiments of the present technology. The first stage can be executed by the processor 401 of the computing device.

### Step 110: Crawling, by the Processor, the Network to Identify a Plurality of Publication Sources

The first stage 100 commences at step (110) where processor 401 can be configured to crawl the communication network to identify publication sources. The processor 401 can be configured to crawl the communication network using any approach, using any program implementing the functions of a web parser, i.e. an automatic “collector” of publications from various web resources, such as CloudScrape or Scrapinghub. In some non-limiting embodiments of the present technology, prior to crawling, the processor 401 can be configured to set language or languages in which the publications are to be identified (for example, Russian, or Russian and English). In other non-limiting embodiments of the present technology, the processor 401 can be configured to crawl the communication network without being limited to any language of the publication sources.

Further, in some non-limiting embodiments of the present technology, the processor 401 can be configured to retrieve publications, such as web pages, from the so identified plurality of publication sources for further analysis. Automated processing (parsing) of such web pages, for example, can be performed, by the processor 401, executing a preliminarily prepared script, to extract, from at least some of the plurality of publication sources, links to other publication sources and thus replenish the general list of publications with the extracted links.

Further, in some non-limiting embodiments of the present technology, the processor 401 can be configured to identify publication sources by analyzing e-mails, including unsolicited emailing (spam). To that end, the processor 401 can be configured to use any method. For example, a number of e-mail accounts may have been registered in advance, the addresses of which may have been put out in the open. Such addresses, as a rule, soon can be added in spam mailing lists, and these addresses begin to receive e-mails, including those containing links to various publication sources listed above. The automated processing (parsing) of such e-mails, for example, performed by the preliminarily prepared script, could be used to extract links to publication sources from them and replenish the general list of publications with the extracted links.

Thus, the processor 401 can be configured to retrieve the plurality of publication sources and the publications posted therein.

Further, in some non-limiting embodiments of the present technology, the processor 401 can be configured to analyze the so retrieved publications to identify and save, in the database, for a given publication, at least one of: title, (author's) account, hyperlink (URL) to a respective web page of the given publication, time of being made publicly available on the communication network (time and date of publication), its source, for example, formed by truncating a hyperlink to a second or third level domain name, as well as content of the given publication, such as a text thereof. For example, in some non-limiting embodiments of the present technology, to conduct such an analysis, the processor 401 can be configured to have access to one or more web parsers. In other non-limiting embodiments of the present technology, the processor 401 can be configured to execute a specific script configured to parse the web page to identify the above-mentioned data associated with the given publication.

For example, as a result, the processor 401 can be configured to identify the given publication as including at least one of: a publication titled “Attention!” comprising the text: “I heard there will be imposed a pet tax soon!”, published from the sample user account, with the date and time of publication as 02/11/2021 17:21:35, a hyperlink to this publication: livejournal.com/sampleuser/12345678.html and also the source: sampleuser.livejournal.com could be stored in the database.

The first stage 100 of the method proceeds to step 120.

Step 120: Identifying, in the Plurality of Publication Sources, Suspicious Publication Sources Having been Used for Posting

### Suspicious Publications, the Suspicious Publications for Executing Reputation Cyberattacks in the Network

At step 120, the processor 401 can be configured to identify, in the plurality of publication sources, suspicious publication sources that can be used for conducting reputation attacks by positing suspicious publications therein. According to certain non-limiting embodiments of the present technology, the suspicious publication sources the processor 401 can be configured to identify in the plurality of publication sources include, for example, without limitation: social networks, compromising material aggregators, data leak aggregators, sign-in platforms.

It should be noted that permanent use of one and the same domain name is typical for all the above-listed publication sources. Generally, a significant portion of such sources' budget is advertising revenue; quite often they run their own advertising campaigns attracting new users. Therefore, the domain names of such sources remain unchanged for years, which, in turn, enables to have permanent lists of domain names, which can be used the suspicious publication sources.

For example, the processor 401 can have access to separate lists, for example, “Social Networks” list, which stores such domain names as facebook.com, vk.com, livejournal.com, etc., “Compromising Material Aggregators” list, which stores domains names like compromat.ru or compromat.livejournal.com, “Data Leak Aggregators” list, which stores domain names like wikileaks.com, and also “Sign-in Platforms” list, which comprises domain names like change.org, democrator.ru, e-petition.am, etc.

Thus, the processor 401 can be configured to check each publication source of the plurality of publication sources against each of the lists. In response to determining, for the given publication source, a match in at least one lit, the processor 401 can further be configured to assign a respective tag to the given publication source.

Returning to the above example, for a publication identified at livejournal.com/sampleuser/12345678.html, and also for all the other publications identified on the livejournal.com domain, the tag “Social Networks” will be assigned, by the processor 401, in the database, as livejournal.com domain name can be pre-added in the “Social Networks” list.

It is should be noted that a given domain name can pre-added to different lists. For example, the “Social Networks” list may contain livejournal.com domain name, while the “Compromising Material Aggregators” list may contain such domain names as slivaem-kompromat.livejournal.com, compromat.livejournal.com, etc.

Further, according to certain non-limiting embodiments of the present technology, the plurality of suspicious publication sources can further include groups of related publication sources. Thus, the step 120 of the first stage 100 can further include identifying, by the processor 401, the groups of related publication sources.

With reference to FIG. 1B, there is depicted a flowchart diagram of a first additional method 1210 for identifying groups of related publication sources, executed as part of the step 120 of the first stage 100, in accordance with certain non-limiting embodiments of the present technology. The first additional method 1210 can also be executed by the processor 401 of the computing device.

It should be noted that all publication sources that have been previously classified at using the above-mentioned lists are not excluded from further processing during the next step (140), since, for example, a social network group (public) could function as, for example, an advertising platform or be a part of a group of the related sources.

The first additional method 1210 begins with selection (1211) of the a given publication from the publications identified at step 110. Then, at sub-step (1212), the processor 401 can be configured to determine whether there are duplicates of the given publication among all the identified publications. In this case, a duplicate means a strict coincidence of the content of the given publication, such as text with the text of any other publication.

More specifically, at sub-step (1212), the processor 401 can be configured to search the database for all publications from the plurality of publication sources, for which the text in the database “Publication Text” exactly matches the text of the given publication.

If no duplicates have been identified at sub-step (1212), that is, there is no publication, which text matches the text of the given publication, the method returns to sub-step (1211), where the processor 401 retrieves the an other publication from the database.

However, if the processor 401 has identified duplicates of the content of the given publication, that is, at least one publication is identified, which text exactly matches the text of the given publication, the method proceeds to sub-step (1213).

At sub-step (1213), the processor 401 can be configured to generate a group of candidate related publication sources based on publication sources associated with publication identified at sub-step (1212). Further, the processor 401 can be configured if the publication time for each of the duplicates of the given publication among the group of candidate related publication sources is the same within a predetermined time threshold value dT, which can be, for example, 30 seconds.

Further, the processor 401 can be configured to remove from further considerations those of the group of candidate related publication sources, for which respective time difference values between the publication time of posting the given publication and posting the duplicates thereof are greater than the predetermined time difference threshold value dT.

For example, if at sub-step (1212), the processor 401 has identified the following candidate related publication sources as posting duplicates of the given publication, the processor 401 can further be configured to determine the publication time values associated with posting these duplicates that are, for example, as follows:
sampleuser.livejournal.com 11.02.2021 17:21:35
website.com 11.02.2021 17:21:07
sample.newspaper.ru 11.02.2021 17:21:59
examplechange.org 15.02.2021 07:01:06
   then, as a result, at sub-step (1213), given the predetermined time difference threshold value dT is 30 seconds, the processor 401 can be configured to keep only the following publication in the group of the candidate related publication sources:
sampleuser.livejournal.com
website.com
sample.newspaper.ru

Further, the method proceeds to sub-step (1214), where the processor 401 is configured to determine if the so filtered group of candidate related publication sources is zero (empty). If the group of candidate sources is determined as being zero, that is, if all identified publications are made by candidate sources with the time difference greater than dT, then the group of candidate sources is deleted, and the first additional method 1210 returns to sub-step (1211), where the next publication is received by the processor 401.

If the processor 401 determines that the group of candidate related publication sources is nonzero, that is, at least two candidate sources are identified that have posted publications with the same text with the time difference not exceeding the predetermined threshold time difference value dT, then the group of the candidate related publication sources is saved, the initial value J=1 is assigned to the enumerative variable J, which value is stored associated with each such group. The first additional method 1210 advances to sub-step (1215).

At sub-step (1215), the processor 401 can be configured to determine whether at least one of the candidate related publication sources identified at the previous sub-steps has been identified again, that is, more than once. In other words, the processor 401 can be configured to determine whether at least one of the candidate related publication sources identified at sub-step (1214) is included in at least one other group of candidate related publication sources that have been previously determined and stored.

Further, in some non-limiting embodiments of the present technology, if all candidate related publication sources identified at step (1214) are absent in all previously stored groups of candidate related publication sources, that is, the group of candidate related publication sources identified at step (1214) is new, the first additional method 1210 returns to step (1211), where the processor 401 is configured to receive the next publication.

If at sub-step (1215), the processor 401 determines that at least one candidate related publication source included in at least one previously stored group, the first additional method 1210 proceeds to sub-step (1216).

At sub-step (1216), the processor 401 can be configured to aggregate groups of candidate related publication sources, where the same candidate related publication sources have been identified. To that end, the processor 401 can be configured to execute: adding all candidate related publication sources available in each group to the new combined group, and if a given candidate related publication source is in more than one group, it is not added again; then, storing the resulting combined group. Then all the values of the enumerative variable J associated with each of the identified groups are summed up, and the resulting value J is assigned to the combined group. Then, the processor 401 can be configured to delete all previous groups of candidates and store only the resulting combined group of candidate related publication sources.

For example, if during execution of sub-step (1215) in relation to the previously shown group of candidate sources, which had the value J=1:
sampleuser.livejournal.com
website.com
sample.newspaper.ru
   one of these sources is identified in the other previously stored groups of candidate related publication sources with the value J=3, for example,
anotherwebsite.es
sampleuser.livejournal.com
justasite.co.il
   then, at sub-step (1216) these two groups are combined into one combined group as follows:
sampleuser.livejournal.com
website.com
sample.newspaper.ru
anotherwebsite.es
justasite.co.il.
   and the processor 401 can be configured to determine the enumerative variable J value for this new combined group as follows

J=1+3=4.

In a specific non-limiting example, if, at sub-step (1215), the processor 401 identifies a previously saved groups of candidate related publication sources including the same sources as the group created at step (1214), i.e., two completely identical groups are identified, then the processor 401 can be configures to summate the values of the enumerative variable J associated therewith, remove one of these groups, and assign the final total value of the variable J to the remaining group.

Further, the first stage 100 of the present method proceeds to sub-step (1217), where the processor 401 is configured to compare the enumerative variable J value obtained at sub-step (1216) to a predetermined threshold value Jmax. This predetermined threshold value can be selected at the stage of setting up the system that implements the method. It has a meaning of the number of “group” publications posted at different times by overlapping or matching source groups of candidates, and it could be, for example, equal to 3.

Thus, if the processor 401 determines that the value of the enumerative variable J obtained at sub-step 1216 is smaller than or equal to the predetermined threshold value Jmax, the first additional method 1210 returns to sub-step (1211), where the processor 401 is configured to receive the next publication.

However, if the processor 401 determines that the value of the enumerative variable J is greater than the threshold value Jmax, the method proceeds to sub-step (1218), where the processor 401 is configured to generate a given group of related publication sources including therein all publication sources included in the combined group of candidate related publication sources as mentioned above. In other words, the group of candidates for which J>Jmax is considered to be a group of related publication sources, which the processor 401 can be configured to store in the database for further analysis. Further, in additional non-limiting embodiments of the present technology, the processor 401 can be configured to assign, in the database, for all the publication sources included in the given group of related publication sources, the corresponding tag, “Group of Related Sources”.

Further, the first additional method 1210 returns to sub-step (1211), where the processor 401 can be configured to receive the next publication source for analysis.

The first additional method 1210 can be executed cyclically until the end of the publication list, from which publications are selected at sub-step (1211).

The first additional method 1210 thus terminates.

In additional non-limiting embodiments of the present technology, the plurality of suspicious publication sources can further include advertising platforms, user feedback aggregators, account exchanges, SMM service exchanges, and web resources for hiring remote workers (freelance exchanges). To that end, at step 120 of the first stage 100, the processor 401 can further be configured to identify such publication sources in the plurality of publication sources obtained at step 110.

With reference to FIG. 1C, there is depicted a flowchart diagram of a second additional method 1220 for identifying, by the processor 401, advertising platforms, user feedback aggregators, account exchanges, SMM service exchanges, and web resources for hiring remote workers executed as part of step 120 of the first stage 100, in accordance with certain non-limiting embodiments of the present technology.

The second additional method 1220 commences at sub-step 1221 where the processor 401 can be configured to search the communication network to identify therein web resources functioning as rating agencies are identified. According to various non-limiting embodiments of the present technology, search can be performed by any method, such as that including use of a search engine, for example, Google™. Also, in some non-limiting embodiments of the present technology, the processor 401 can be configured to use preliminarily prepared sets of strings are used as keywords, enabling to generate a corresponding search query, for example, without limitation:
“rating of SMM exchanges”;
“rating of account exchanges”;
“rating of freelance exchanges”;
“rating of the best user feedback aggregators”; and others

Then, by analyzing the search results, such as by using a preliminarily developed script, the processor 401 can be configured to extract hyperlinks (URLs) to web resources functioning as rating agencies, and store these hyperlinks in the form of a list by categories, such as, without limitation, a list of ratings of SMM exchanges, a list of ratings of account exchanges, etc. Thus, as a result of sub-step (1221), the processor 401 can be configured to obtain the lists of links to the web resources of rating agencies, organized by the website activity specifics.

Further, the second additional method 1220 proceeds to sub-step (1222), where the processor 401 can be configured to crawl the identified web resources of rating agencies. For this purpose, the processor 401 can be provided with access to the lists of URLs generated in step (1221). The processor 401 can be configured to crawl these web resources using, for example, a web parser, i.e. an automatic “collector” of publications from various websites, such as CloudScrape or Scrapinghub.

As a result of sub-step (1222), the processor 401 can be configured to obtain web pages of the crawled web resources and store these web pages in the database. For example, such web pages can include, but not limited to, the ratings as such, i.e. ordered lists of websites functioning as account exchanges, SMM service exchanges, freelance exchanges and user feedback aggregators.

Thus, the second additional method 1220 proceeds to sub-step (1223), where the processor 401 can be configured to generate lists of websites functioning as various exchanges, and also as user feedback aggregators, as described above. Thus, the processor 401 can be configured to obtain the following lists of links:
a list of links to account exchanges,
a list of links to SMM service exchanges,
a list of links to freelance exchanges, and
a list of links to user feedback aggregators (1)

The processor 401 can further be configured to store these lists, for example, in the database. The second additional method 1220 hence advances to sub-step (1224), where the processor 401 can be configured to analyze and filter the so generated lists of various exchanges. For example, the processor 401 can be configured to delete duplicate entries from the above lists, that is, duplicate links (URL). Also, at this sub-step, the processor 401 can be configured to truncate the obtained links to the second level domain. For example, a URL
example-otzovik.su/index.html
can be converted to
example-otzovik.su.

Thus, at sub-step (1224), the processor 401 can be configured to generate four source lists corresponding to the list (1) store them in the database.

Then, the second additional method 1220 proceeds to sub-step (1225), where the processor 401 can be configured to crawl each one of the list of account exchange web resources. obtained at sub-step 1224. The processor 401 can be configured to crawl these web resources using, for example, a web parser, i.e. an automatic “collector” of publications from various websites, such as CloudScrape or Scrapinghub.

Thus, at sub-step (1225), the processor 401 can obtain (i) web pages of the crawled account exchange web resources; and (ii) store these web pages in the database. These web pages can include, for example, but not limited to, lists of accounts offered for sale or lease.

It should be noted that accounts offered for sale or lease on account exchange web resources can be controlled by bots.

Thus, at sub-step (1226), according to certain non-limiting embodiments of the present technology, the processor 401 can be configured to analyze the web pages stored at sub-step (1225) to extract therefrom names of the accounts offered for sale or lease. By doing so, the processor 401 can be configured to generate a list of bot accounts, that is, including accounts controlled by bots. To analyze each of the web pages in such a way and extract the data therefrom, such as the names of the accounts, the processor 401 can be configured to execute a specific script parsing a web page, extracting account names from it and storing them into a separate list.

In some non-limiting embodiments of the present technology, the processor 401 can be configured to use the list of bot accounts to identify bot accounts amongst those accounts obtained as part of the publications at step 110 of the first stage 100 of the present method—for example, the processor 401 can be configured to assign to those accounts the respective tag “Bot”.

Further, the processor 401 can be configured to store, in the database, those accounts that are present in the list of bot accounts obtained at sub-step (1226), but have been absent in the database with the “Bot” tag.

An alternative embodiment of the described method is also possible, wherein step (1226) is omitted, proceeding from sub-step (1225) to sub-step (1227).

The second additional method 1220 therefore advances to sub-step (1227), where the processor 401 can be configured to crawl each one of the list of freelance exchanges obtained at sub-step (1224). As noted above, the processor 401 can be configured to crawl these web resources using, for example, a web parser, i.e. an automatic “collector” of publications from various websites, such as CloudScrape or Scrapinghub.

As a result of sub-step (1227), the processor 401 can be configured to obtain web pages of the crawled freelance exchange web resources and store them in the database. According to certain non-limiting embodiments of the present technology, these web pages can include, for example, but not limited to, texts of tasks for freelancers to post reviews with a predetermined focus on the pages of any given web resources.

It should be noted that the web resources on which freelancers are invited to post reviews with the predetermined focus can relate to the category of advertising platforms, i.e., they are online media that publish, in addition to regular news, paid publications with the predetermined focus.

Therefore, at the next sub-step (1228), the processor 401 can be configured to (i) analyze the web pages stored at sub-step (1227); and (ii) extract links (URLs) to advertising platforms therefrom. By doing so, the processor 41 ca be configured to generate a list of advertising platforms. Similarly, the processor 401 can be configured to analyze the web pages using a script configured to parse a web page, extract URLs therefrom it and store the links in a separate list.

Further, the second additional method 1220 proceeds to sub-step (1229), where the processor 01 can be configured to analyze and filter the so generated list. To that end, the processor 401 can be configured to delete all duplicate entries from the list, that is, duplicate links (URL). Also, at this sub-step, the processor 401 can be configured to truncate the obtained links to the second level domain, such that a URL
reklamnoe-smi.ru/index.html
is converted to
reklamnoe-smi.ru.

Thus, as result of executing step 120 of the first stage 100 of the present method for detecting the reputation attacks, the processor 401 can be configured to obtain the categorized plurality of suspicious publication sources for further analysis. As noted above, a given publication source may simultaneously be classified into different types of sources, and hence more than one tag could be assigned to the given publication source.

In some non-limiting embodiments of the present technology, the processor 401 can be configured to further analyze only the publication sources, whose types have been determined at step (120). However, in other non-limiting embodiments of the present technology, the processor 401 can be configured to further analyze all publication sources that have been obtained at step 110.

The first stage 100 thus advances to step 130.

### Step 130: Identifying, by the Processor, in Each of the Suspicious Publication Sources, Suspicious User Accounts Having Posted the Suspicious Publications

Further, at step 130 of the first stage 100 of the present method, the processor 401 can be configured to identify, in the plurality of suspicious publication sources identified at step 120, suspicious user accounts, such as those controlled by the bots, that have posted suspicious publication thereat.

With reference to FIG. 1D, there is depicted a schematic diagram of step 130 for identifying, by the processor 401, the suspicious user accounts, in accordance with certain non-limiting embodiments of the present technology.

Step (130) begins at sub-step 131, where the processor 401 can be configured to select publications posted on social networks among the identified plurality of publications. Since earlier, as a result of step (120), the publication sources, which are social networks, have been classified, execution of sub-step 131 includes the processor 401 selecting, from the database, publications, which have been marked as “Social network” in the database. For example, the processor 401 can be configured to generate a respective a corresponding SQL query to the database and receiving a response to it.

In the context of the present specification, a given publication on a social network can include at least one of:
entry (original message),
comment (reply to someone's entry or comment),
repost, that is, posting on its own behalf any entry made by another user, indicating their account and link to the original entry.

Alternative means of social network users' interaction, such as emoticons and likes/dislikes (votes “for” and “against”) are not taken into account during execution of this step.

After receiving publications on social networks, step 130 proceeds to sub-step 132, where the processor 401 can be configured to identify, for a given account, a respective set of publications made therefrom. Since earlier, in the course of step (110), the accounts from which all publications were made have been identified, technically, sub-step 132 is filtering the resulting array of publications by each author (account). The processor 401 can be configured to access the account names the general list of accounts stored in the database, generated, as described above, at step (110) and sub-step (1226).

Prior to filtering the resulting array of publications (in FIG. 1D, this sub-step is not shown for the sake of simplicity), in some non-limiting embodiments of the present technology, the processor 401 can be configured to determine whether the given account has already the “Bot” tag. Such a tag could have been assigned earlier, during execution of sub-step (1226) of the second additional method 1220 described above. If such a tag is present, sub-step 133 is not executed, and step 130 proceeds to a next account from the list of accounts.

Alternatively, if the tag “Bot” has not been assigned to the given account, step 130 proceeds to sub-step 133, where the processor 401 can be configured to determine a number M of publications made by the given account over a predetermined reference interval, for example, 0.1, 0.5, 1, 5, or 10 seconds. To that end, the processor 401 can be configured to order the publications by publication date and time, and then, determine the time intervals between each two publications adjacent in time. For example, if the given account has consecutively made publications P1, P2, P3 and P4, the processor 401 can be configured to determine the intervals between P1 and P2 publications, between P2 and P3, and between P3 and P4. Then, the processor 401 can be configured to determine the M value corresponding to a number of intervals, whose duration is shorter than or equal to the predetermined reference interval.

Then, step 130 proceeds to sub-step 134, where the processor 401 can be configured to compare the so determined M value to a predetermined threshold value. For example, this predetermined threshold value could be selected empirically at the stage of the system setup, and could be, for example, 4. If the M value for the analyzed given account exceeds this predetermined threshold value, step 130 proceeds to sub-step 137, where the processor 401 can be configured to assign the given account to those accounts that are controlled by bots. Further step 130 returns to sub-step 132.

If, at sub-step 134, the M value for the analyzed given account is less than the predetermined threshold value, step 130 proceeds to sub-step 135, where the processor 401 can be configured to determine a period T within which the given account has made publications with at least a reference frequency F. In this case, the reference frequency F value could be selected in advance, at the stage of the system setup. For example, F could be selected as equal to one publication per hour or one publication per two hours.

For example, if the given account has made publications P1, P2 . . . P400 in a consecutive manner, then, at sub-step 134, the processor 401 can be configured to (1) order these publication by the publication date and time; (2) determine the time intervals between each two publications adjacent in time, such as between P1 and P2, between P2 and P3, and so on, up to the interval between P399 and P400; and (3) identify periods T1, T2, T3, etc., such that within each one thereof the frequency of publications exceeds or equal to the predetermined reference F value. In other words, the processor 401 can be configured to identify all periods, during which the given account has posted publications more often than with the predetermined frequency F.

Then, the processor 401 can be configured to determine the duration of the period T is determined as the maximum period duration among all the identified time periods T1, T2, T3, etc.

Then, step 130 proceeds to sub-step 136, where the processor 401 can be configured to determine whether the duration of the period T exceeds a predetermined period threshold value. For example, this threshold value could be selected as being equal to 36 hours or 48 hours. In other words, at this stage it is checked how long any publications have been posted from the given account continuously, without a pause required for an average human user to sleep.

Thus, if the processor 401 determines that the period T exceeds the predetermined period threshold value, step 130 proceeds to sub-step 137, where the processor 401 is configured to classify the given account into the accounts controlled by bots, that is, assign the tag “Bot” to it in the database. Further, step 130 returns to sub-step 132. Otherwise, if the value of T does not exceed a preset threshold, step 130 returns to sub-step 132.

It should be understood that the execution of step (130) terminates when an end of an account list is reached, that is, when the database includes no more accounts for analysis. In this case, the first stage 100 advances to step 140, as described above with reference to FIG. 1A.

It should be expressly understood that steps (110), (120), (130), and (140), of the first stage 100 are depicted as being executed sequentially only for simplicity and clarity of the present description. In alternative non-limiting embodiments of the present technology, these steps can be executed cyclically, or in parallel with the steps that will be described below in relation to the second stage of the present method of detecting the reputation attacks. Also, in some non-limiting embodiments of the present technology, the execution of the first stage 100 could be carried out continuously, which enables to seed the databases constantly, and to have “fresh”, actual information in the database at any time.

The first stage thus advances to step 150.

Step 150: Storing, by the Processor, Data of the Suspicious Publication Sources and that of the Bot User Accounts Having Posted the Suspicious Publications Thereon in a Database

Finally, at step (170) of the first stage (100), the processor 401 can be configured to store all the information obtained at the previous steps in the database. The first stage (100) hence terminates.

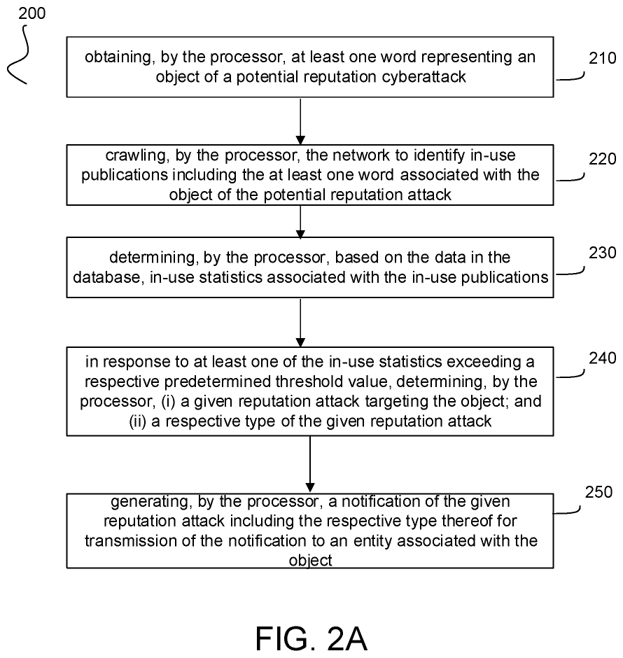

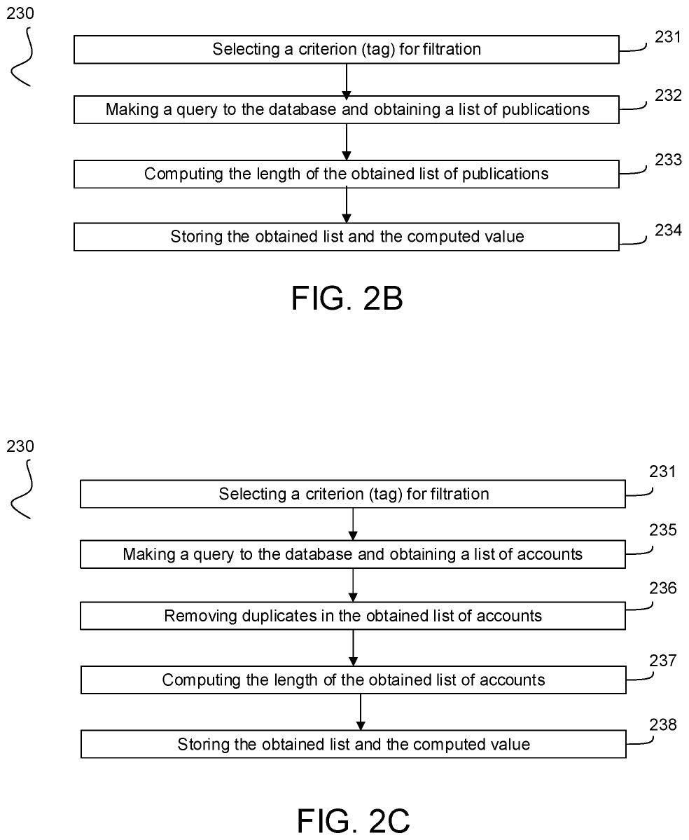

Further, as alluded to above, the present method for detecting the reputation attacks can proceed to the second stage which follows the first stage 100. With reference to FIG. 2A, there is depicted a flowchart diagram of the second stage 200, in accordance with certain non-limiting embodiments of the present technology.

### Step 210: Obtaining, by the Processor, at Least One Word Representing an Object of a Potential Reputation Cyberattack

The second stage (200) begins with step (210), where the processor 401 can be configured to obtain at least one word or a phrase representative of an object of the reputation attack. For example, the processor 401 can be configured to receive a text string comprising the at least one word representative of the object of the reputation attack. In some non-limiting embodiments of the present technology, the processor 401 can be configured to receive the text string from the database

However, in alternative non-limiting embodiments of the present technology, the processor 401 can be configured to receive the text string via import thereof from the text of an email sent to a prearranged email address associated with the computing device implementing the described method, etc.

The second stage 200 hence advances to step 220.

Step 220: Crawling, by the Processor, the Network to Identify In-Use Publications Including the at Least One Word Associated with the Object of the Potential Reputation Attack

According to certain non-limiting embodiments of the present technology, at step 220, the processor 401 can be configured to crawl the communication network to identify in-use publication including the at least one word representative of the object of the reputation attack received at step 210 above. For example, the processor 401 can be configured to crawl the communication network in a manner similar to that described above with respect to step 110 of the first stage 100 of the present method.

In additional non-limiting embodiments of the present technology, prior to the crawling, as will become apparent from the description provided below, the processor 401 can further be configured to obtain and store system clock readings of the computing device, that is, an indication of a current time provided by the computing device.

In additional non-limiting embodiments of the present technology, the processor 401 can further be configured to identify and extract from the in-use publications all links (such as URLs thereof) and store them as well in the database. The processor 401 can be configured to extract the links similarly to execution of the respective step of the first stage 100, that is, by the pre-configured script.

The second stage 200 hence advances to step 230.

Step 230: Determining, by the Processor, Based on the Data in the Database, In-Use Statistics Associated with the In-Use Publications

At step (230), the processor 401 can be configured to analyze the identified in-use publications to determine at least the following data associated therewith: a title, an author's account, publication's date and time, publication source, publication content, such as text. In accordance with certain non-limiting embodiments of the present technology, the processor 401 can be configured to determine this data of the in-use publications in a manner similar to that described above with respect to step 110 of the first stage 100 of the present method. Further, the processor 401 can be configured to store the so extracted data in the database.

Further, based on the data preliminary stored in the databased and the data obtain from the in-use publications, the processor 401 can be configured to determine in-use statistics associated with the in-use publications. In accordance with certain non-limiting embodiments of the present technology, the in-use statistics are indicative of at least one of: (i) quantitative characteristics associated with the in-use publications and (ii) how the quantitative characteristics change over time.

A non-exhaustive list of the quantitative characteristics, in some-limiting embodiments of the present technology, can include, without limitation, at least the following: (2)
a total number of in-use publications N,
a number of in-use publications made by bots, Nb,
a number of in-use publications made on compromising material aggregators, Nk,
a number of in-use publications made by groups of related publication sources, Ng
a number of in-use publications made on publication sources that have been classified as both groups of related sources and compromising material aggregators, Ngk
a number of in-use publications made on advertising platforms, Nr,
a number of in-use publications made on advertising platforms being part of the group of related sources, Ngr,
a number of in-use publications made on user feedback aggregators, No,
a number of in-use publications made on data leak aggregators, Nu,
a number of in-use publications made on sites for hiring remote workers, Nh,
a total number of in-use publications duplicating each other, Nd,
a total number of in-use publications on compromising material aggregators duplicating each other, Ndk,
a total number of in-use publications on compromising material aggregators duplicating each other and made by bots, Ndbk,
a total number of links duplicating each other, Nld,
a number of accounts from which the identified in-use publications have been posted, Na
a number of accounts controlled by bots from which the identified in-use publications have been posted, Nab,
a number of accounts from which the in-use publications identified on compromising material aggregators have been posted, Nak,
a number of accounts, controlled by bots, from which the in-use publications have been posted on compromising material aggregators, Nabk, and
a number of accounts from which the in-use publications identified on advertising platforms have been posted, Nar.

Further, to determine how the above quantitative characteristics change over time, in some non-limiting of the present technology, the processor 401 can be configured to determine values thereof within a predetermined time interval t with the predetermined increments (time interval between iterations) ts. By way of non-limiting example, the predetermined time interval t could be set as equal to 10 minutes, and the step ts as equal to 1 minute.

As it can be appreciated, the quantitative characteristics could be combined into three main groups: (1) characteristics representative of a number of certain in-use publications; (2) characteristics representative of a number of duplicates (repetitions); and (3) characteristics representative of a number of user accounts.

With reference to FIG. 2B, there is depicted a flowchart diagram of step 230 for determining, by the processor 401, the characteristics representative of the number of in-use publications, in accordance with certain non-limiting embodiments of the present technology.

Since during the first stage 100, namely, at step 120 thereof, various sources of publications and accounts have been tagged, that is, the processor 401 has tagged at least some of them in the database as “Compromising Material Aggregator”, “Group of Related Sources”, “Bot” and so on, the processor 401 can now be configured to identify the number of in-use publications related to certain sources from the database by searching for respective entries therein corresponding to a given tag.

Thus, at sub-step 231, the processor 401 can be configured to select at least one filtration criterion (tag). It is selected from the preliminarily prepared list of tags, for example, alternately selecting one tag after another.

Then, at sub-step 232, the processor 401 can be configured to generate a query to the database comprising the selected tag to further generate a list of in-use publications corresponding to this query. Further, at sub-step 233, the processor 401 can be configured to determine a length value of this list, i.e. the number of the in-use publications corresponding to the selected tag. Then, at sub-step 234, the processor 401 can be configured to the determined length value. In additional non-limiting embodiments of the present technology, the processor 401 can further be configured to store the list of the identified in-use publications as well.

As an example, below, there is provided a detailed description of how the processor 401 can be configured to determine the number of in-use publications Nb made by bots. During the first stage 100, the processor 401 has identified the accounts controlled by bots, and each of these accounts has been tagged as “Bot” in the database.

Thus, at sub-step 231, the processor 401 can be configured to: (i) obtain the “Bot” tag from the tag list; (ii) at sub-step 232, generate the respective query, including this tag, to the database; (iii) retrieve, from the database, a list of in-use publications identified at step (220) and made from accounts tagged as “Bot”. Depending on the architecture of the database used, to generate and submit queries to the database, the processor 401 can be configured to use, for example, an SQL notation.

Then, the processor 401 can be configured to determine the length, that is, the number, of the list of the in-use publications, which is thus representative of a number of publications Nb made by bots. Further, the processor 401 can be configured to store the value of Nb in the database. Additionally, the processor 401 can be configured to store the list of the in-use publications itself.

Further, in accordance with certain non-limiting embodiments of the present technology, in order to determine the total number of identified in-use publications N at sub-step 232, the processor 401 can be configured not to generate a query to the database, and determine the value of N as being equal to the total number of in-use publications (that is, web pages thereof, for example) stored at the current iteration of step (220). For example, at the first iteration of the second stage 200, at step (220), the processor 401 can be configured to identify and further store in the database100 in-use publications, and N value=100. At the second iteration of the second stage 200, the number of the identified in-use publications could become equal to 110, and N value=110 will be stored in the database. At the third iteration of the second stage 200, the number of the identified in-use publications could become equal, for example, to 130, and N value=130 will be stored in the database.

It should be expressly understood that, in various non-limiting embodiments of the present technology, the processor 401 can be configured to store the values of all quantitative characteristics determined by the processor 401 at step (230) in the database, for example, in a form of a vector, i.e. a sequence of numbers. For example, as a result of the above iterations, the following sequence of values will be saved for N characteristic:

N=(100,110,130).

In another example, the processor 401 can be configured to use two tags to determine the number of in-use publications made by groups of related sources, which are also the compromising material aggregators (Ngk): “Compromising Material Aggregators” and “Group of Related Sources”. To generate the respective query to the database, the processor 401 can be configured to combine these two tags by logical AND, thus obtaining the list of in-use publications having both of these tags assigned their respective sources, as described above with respect to the first stage 100.

Then, the processor 401 can be configured to determine the length, that is, the number, of the list is determined, which is thus indicative of a number of Ngk publications made by publication sources having been classified as being both groups of related sources and the compromising material aggregators. Further, the processor 401 can be configured to store the value of Ngk in the database. Additionally, the processor 401 can be configured to store the list of the in-use publications itself.

Further, in some non-limiting embodiments of the present technology, the processor 401 can be configured to determine the quantitative characteristics indicative of the number of duplicates (repetitions) in two steps. At the first step, the processor 401 can be configured to obtain, from the database, a set of entries, within which it is necessary to find duplicates. For example, in order to determine the total number of in-use publications duplicating each other and posted on the compromising material aggregators (Ndk), the processor 401 can be configured to obtain a list of publications posted on the compromising material aggregators.

In this example, the processor 401 can be configured to use the list obtained after the determining the number of in-use publications made on the compromising material aggregators (Nk), and stored at sub-step 234. In another example, in order to determine the total number of links duplicating each other (Nld), the processor 401 can be configured to use the data obtained in the course of step (210), where the links (URLs) available in the identified in-use publications have been extracted and stored. In this case, the processor 401 can be configured to generate a respective query to the database.

At the second step, the processor 401 can be configured to determine the number of duplicates within the resulting list. Determining the total number of in-use publications duplicating each other and posted on the compromising material aggregators (Ndk), the processor 401 could be performed analogously to sub-step 1212 of the first additional method 1210 described above. In order to determine the number of duplicates in the list of links, the processor 401 can be configured to apply a similar algorithm, with the only difference being that search in the database is carried out not in the “Publication” field, but in the “Hyperlink” field.

Further, with reference to FIG. 2C, there is depicted a flowchart diagram of step 230 for determining the quantitative characteristics representative of the number of user accounts associated with the in-use publications at step 220, in accordance with certain non-limiting embodiments of the present technology. First, as it can be appreciated form FIG. 2C, the determining the quantitative characteristics representative of the number of user accounts begins at sub-step 231, where the processor 401 can be configured to select at least one criterion (tag), which in the present example, can be the “Bot” tag. Similarly, this tag is selected from the preliminarily prepared list of tags.

Further, at sub-step 235, the processor 401 can be configured to generate a respective query to the database including the selected tag, thereby generating a list of accounts corresponding to this query.

Further, at sub-step 236, the processor 401 can be configured to filter the obtained list excluding therefrom repetitions. Then, at sub-step 237, the processor 401 can be configured to determine a length of the list of accounts, that is, the number of accounts meeting the criterion represented by the selected tag. Then, at sub-step 238, the processor 401 can be configured to store the obtained number value in the database. Additionally, the processor 401 can be configured to store in the database the list of accounts, as well.

For example, the processor 401 can be configured to determine the number of accounts controlled by bots from which publications have been posted on the compromising material aggregators (Nak) from the list of in-use publications made on the compromising material aggregators. To that end, the list of in-use publications could be obtained as a result of executing sub-steps (231) to (234), or regenerated by requesting all the publications made on sources tagged as “Compromising Material Aggregator” from the database. Then, the processor 401 can be configured to extract, from the list of the in-use publications made on sources tagged as “Compromising Material Aggregator” such as by submitting a respective query to the database, a list of accounts, from which they have been made, and having the “Bot” tag. Further, the processor 401 can be configured to filter the resulting list of accounts removing therefrom duplicates. Thus, the processor 401 can be configured to determine the length of the so obtained list after the filtration as being the value of the number of Nak accounts. Finally, the processor 401 can be configured to store this value in the database.

In some non-limiting embodiments of the present technology, the processor 401 can be configured to omit sub-step 231 from execution of step 230. In this regard, in order to determine the total number of accounts from which the identified publications (Na) have been posted, the processor 401 can be configured to extract, from the database, a complete list of accounts, from which the in-use publications have been made. Then, the processor 401 can be configured to remove duplicates from this list, in other words, leaving one entry of each account in it. Number of lines of the so obtained list is considered to be the number of accounts from which the identified in-use publications Na have been posted, which the processor 401 can be configured to store.

Thus, returning to FIG. 2A, at step (230) the values of the quantitative characteristics are determined and stored in the database. Further, in accordance with certain non-limiting embodiments of the present technology, for example, using the readings of the system clock registered at step (220), the processor 401 can be configured to determine time Tr that has elapsed since the beginning of the current iteration of determining the quantitative characteristics as mentioned above. Thus, the processor 401 can be configured to determine the time elapsed from the beginning of step (210) is computed:

Ti=Ti+Tr,

Further, in some non-limiting embodiments of the present technology, the processor 401 can be configured to determine whether the time elapsed exceeds the predetermined time interval t, by comparing t and Ti. Further, if Ti<t, i.e. the time elapsed does not exceed the predetermined time interval, the processor 401 can be configured to maintain a pause dT, which is numerically equal to the difference between the preset step size (interval between iterations) is and time Tr actually elapsed since the beginning of the current iteration:

dT=ts−Tr,

after that the second stage 200 returns to step (220), wherein the processor 401 is configured to crawl the communication network to identify new in-use publication including at least one word (or a phrase) obtained at step (210) characterizing the object of the reputation attack.

However, if Ti>t, i.e. the time elapsed since the beginning of the current iteration exceeds the predetermined time interval, according to certain non-limiting embodiments of the present technology, the processor 401 can be configured to determine trends of the quantitative characteristics mentioned above over the predetermined time interval.

As mentioned before, the processor 401 could be configured to store the values of all quantitative characteristics in the database in the form of vectors, i.e. a sequences of numbers. For example, as a result of execution of steps (220) . . . (230) within the predetermined time interval t, five values have been calculated for each of the quantitative characteristics in the list (2):
N=(N1, N2, N3, N4, N5), (3)
Nb=(Nb1, Nb2, Nb3, Nb4, Nb5),
Nk=(Nk1, Nk2, Nk3, Nk4, Nk5),
Ng=(Ng1, Ng2, Ng3, Ng4, Ng5),
Ngk=(Ngk1, Ngk2, Ngk3, Ngk4, Ngk5),
Nr=(Nr1, Nr2, Nr3, Nr4, Nr5),
Ngr=(Ngr1, Ngr2, Ngr3, Ngr4, Ngr5),
No=(No1, No2, No3, No4, No5),
Nu=(Nu1, Nu2, Nu3, Nu4, Nu5),
Nh=(Nh1, Nh2, Nh3, Nh4, Nh5),
Nd=(Nd1, Nd2, Nd3, Nd4, Nd5),
Ndk=(Ndk1, Ndk2, Ndk3, Ndk4, Ndk5),
Ndbk=(Ndbk1, Ndbk2, Ndbk3, Ndbk4, Ndbk5),
Nld=(Nld1, Nld2, Nld3, Nld4, Nld5),
Na=(Na1, Na2, Na3, Na4, Na5),
Nab=(Nab1, Nab2, Nab3, Nab4, Nab5),
Nak=(Nak1, Nak2, Nak3, Nak4, Nak5),
Nabk=(Nabk1, Nabk2, Nabk3, Nabk4, Nabk5),
Nar=(Nar1, Nar2, Nar3, Nar4, Nar5),

Further, according to certain non-limiting embodiments of the present technology, the processor 401 can be configured to determine, an absolute D (in units) and relative Dr (in percent) difference values between the adjacent values in each vector of the list (3). For example, for the vector of the total number of publications N:
N=(N1, N2, N3, N4, N5).

Thus, for this vector, the processor 401 can be configured to determine the following difference values:
D1=N2−N1,
Dr1=100*(N2−N1)/N1;
D2=N3−N2,
Dr2=100*(N3−N2)/N2;
D3=N4−N3,
Dr3=100*(N4−N3)/N3;
D4=N5−N4; and
Dr4=100*(N5−N4)/N4.

After determining all the difference values of the absolute D and relative Dr difference for each vector of the list (3) obtained for the quantitative characteristics (2), according to certain non-limiting embodiments of the present technology, the processor 401 can be configured to determine whether at least one of D and Dr values exceeds a respective predetermined threshold value.

For example, for the numerical characteristic Ndk, which is representative of the total number of publications on the compromising material aggregators, being duplicates of each other, there could be predetermined a threshold value of 7 for the absolute difference D, and a threshold value of 5% for the relative difference Dr.

At the same time, for the numerical characteristic Nr representative of the number of publications made on advertising platforms, there could be predetermined a threshold value of 3 for the absolute difference D, and a threshold value of 6% for the relative difference Dr, as an example.

Further, for the numerical characteristics of Nd, which is representative of the total number of publications being duplicates of each other, there could be predetermined a threshold value of 95 for the absolute difference D, and a threshold value of 20% for the relative difference Dr.

In other words, the respective predetermined threshold values for the relative and absolute difference could be different for each of the quantitative characteristics listed in (2).

For example, these respective predetermined threshold values could be determined empirically at the stage of the system setup.

If none of D and Dr values is exceeded by the corresponding threshold value, the second stage 200 returns to step (220), where the processor 401 is configured to crawl the communication network to identify new in-use publications including the at least one word or phrase obtained at step (210) characterizing the object of the reputation attack.

However, in response to the any of the D values exceeds the respective threshold value, the second stage 200 advances to step 240.

Step 240: In Response to at Least One of the In-Use Statistics Exceeding a Respective Predetermined Threshold Value, Determining, by the Processor, (I) a Given Reputation Attack Targeting the Object; and (II) a Respective Type of the Given Reputation Attack

At step 240, in response to any of the D values exceeding the respective predetermined threshold value, the processor 401 can be configured to determine that the object is attacked by the reputation attack as well as the type of the reputation attack.

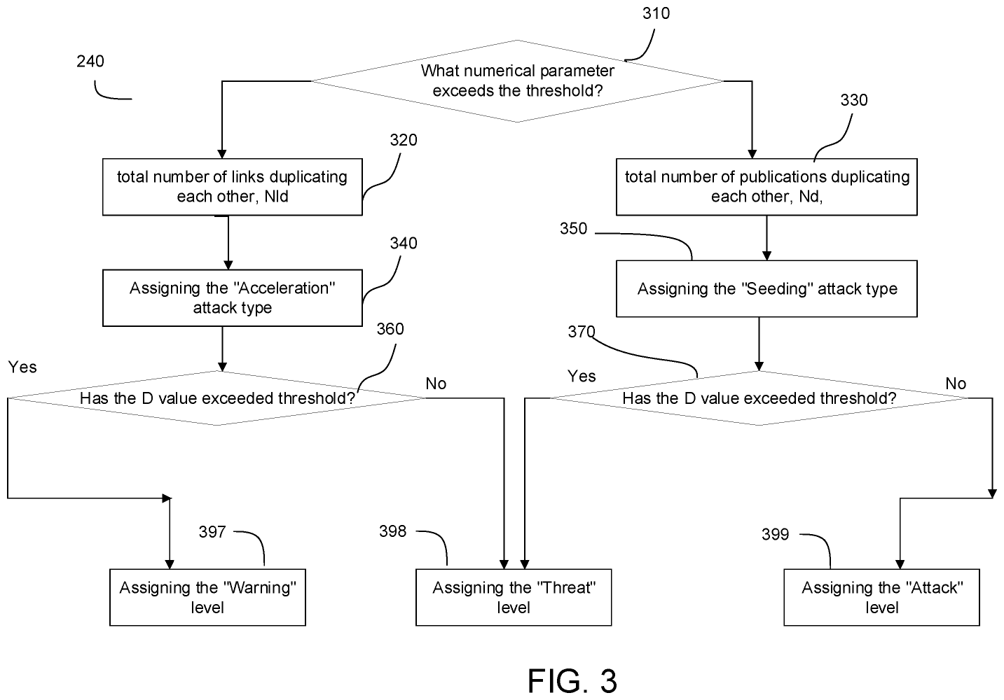

With reference to FIG. 3, there is depicted a flowchart diagram of step 240 of the second stage 200, in accordance with certain non-limiting embodiments of the present technology.

It is worth noting that the algorithm of step 240, as depicted in FIG. 3, is used only for the purposes of illustration and explanation of the non-limiting embodiments of the present technology, and not as a limitation thereof. Thus, for the simplicity of the provided examples, the flowchart of FIG. 3 depicts the algorithm of step 240 based only on two quantitative characteristics Nd (the total number of publications being duplicates of each other) and Nld (the total number of links being duplicates of each other).

Thus, it should be expressly understood that all the quantitative characteristics given in the list (2) could be used for the implementation of step 240. Moreover, step 240 of the second stage 200 of the present method may also include any other, in addition to those shown in FIG. 3, logical dependencies between the characteristics given in the list (2) and be implemented taking into account any predetermined ratios between the numerical values of the quantitative characteristics given in the list (2).

Similarly, the attack methods shown in the flowchart of FIG. 3, that is, those referred to herein as “Seeding” and “Acceleration”, are also provided for illustrative purposes only and thus do not constitute an exhaustive list of possible methods of reputation attack. The described method allows to identify and reveal, without limitation, any methods of reputation attack known to those skilled in the art.

Step 240 begins at sub-step (310), where the processor 401 can be configured to determine i which respective quantitative characteristics of those given in the list (2) relate to the values of the absolute D and/or the relative Dr difference that have exceeded the respective predetermined threshold values.

For example, if the threshold has been exceeded by the Nld value corresponding to the total number of links being duplicates of each other, then step 240 proceeds to sub-step (320), and at sub-step (340), the processor 401 can be configured to assign an “Acceleration” type to the reputation attack. In the context of the present specification, this type of the attack includes distributing the same hyperlink to one material influencing the target audience over a large number of web sites.

Further, step 240 proceeds to sub-step (360), where the processor 401 can be configured to determine a severity level of the reputation, for example, depending on which of the D and Dr values has exceeded the respective predetermined threshold. In this case, if the respective predetermined threshold has been exceeded by the absolute difference D value, then, step 240 proceeds to sub-step (397), where the processor 401 can be configured to assign a “Warning” level to the reputation attack. Otherwise, if the respective predetermined threshold has been exceeded by the relative difference Dr value, then, step 240 proceeds to sub-step (398), where the processor 401 can be configured to assign a “Threat” level to the attack. After that, step 240 ends.

Alternatively, if at sub-step (310), the processor 401 determines that the respective predetermined threshold has been exceeded by the Nd value corresponding to the total number of publications being duplicates of each other, step 240 advances to sub-step (330), and at the next sub-step (350), the processor 401 can be configured to assign a “Seeding” type to the reputation attack. In the context of the present specification, this type of attack includes distribution of one and the same text, whose content is used to influence the target audience, over a large number of web sites.

Then, step 240 proceeds to sub-step (370), where the processor 401 can be configured to determine the severity level of the attack. For example, the processor 401 can do this based on which of the D and Dr values has exceeded the respective predetermined threshold. In this case, if the respective predetermined threshold has been exceeded by the absolute difference D value, then, step 240 proceeds to sub-step (398), where the processor 401 can be configured to assign the “Threat” level to the reputation attack. Otherwise, if the respective predetermined threshold has been exceeded by the relative difference Dr value, then, step 240 proceeds to sub-step (399), where the processor 401 can be configured to assign an “Attack”, highest, level to the reputation attack. Step 240 hence terminates.

It should be noted that the selection at sub-step (310) is not binary, as illustratively depicted in FIG. 3, and may include any number of options corresponding to the number of quantitative in the list (2), which, in turn, correspond D and/or Dr values have exceeded the respective predetermined threshold values. If two, three or more characteristics have been selected, then the sequences of actions corresponding to sub-steps (320) and (330) can be executed simultaneously.

Accordingly, in some non-limiting embodiments of the present technology, several types could be assigned to such a given reputation attack including, for example, the “Seeding” and “Acceleration” types.

Similarly, in some non-limiting embodiments of the present technology, the processor 401 can be configured to assign more than one severity levels to the given reputation attack including, for example, the “Warning” and “Attack” levels could be assigned. In an example, the processor 401 can be configured to select a highest severity level to be assigned to the given reputation attack.

The second stage 200 hence advances to step 250.

Step 250: Generating, by the Processor, a Notification of the Given Reputation Attack Including the Respective Type Thereof for Transmission of the Notification to an Entity Associated with the Object

At step 250, having determined the reputation attack, the type and the severity level thereof, the processor 401 can be configured to generate a respective notification including this information as described above.

In one example, the processor 401 can be configured to include in the respective notification a respective severity level of the reputation attack, including one of: “Warning”, “Threat”, “Attack”. The severity levels indicate levels of attack intensity.

In another example, the processor 401 can be configured to include a numerical expression characterizing the level of attack intensity of the reputation attack, for example, “There has been detected an attack on [the attack object name] with the intensity of I=71%”. Also, the number I could be obtained, for example, by normalizing the absolute D or relative Dr difference values of the respective ones of the quantitative characteristics given in the list (2) to the maximum value identified over the predetermined time interval t:

It shoudl be noted that the severity level of the reputation attack can be determine by any other method based on the numerical values of the quantitative characteristics given in the list (2), for example, as being arithmetic mean values calculated for each of them for the predetermined time interval t, etc.

According to certain non-limiting embodiments of the present technology, the processor 401 can be configured to transmit the respective notification to an entity associated with the object of the reputation attack by at least one of the following methods: by e-mail, by sending an SMS, by sending an MMS, by sending a push notification, by a message in an instant messenger, by creating an API event, and the like.

It should be noted that use of such a notification tool as API events enables to implement additional integration of the described system with various third-party tools, such as public opinion monitoring platforms, security management platforms, SIEM solutions, etc. Actually, the generation of all the listed notifications, such as emails, SMS, MMS, push notifications, etc. could be performed by any well-known method.

In other non-limiting embodiments of the present technology (not shown in FIG. 2A), after generating and sending the notification, the processor 401 ca be configured to switch to waiting for further user commands, for example, entering new words and/or phrases characterizing the object of the reputation attack.

In yet other non-limiting embodiments of the present technology (not shown in FIG. 2A), after generating and sending the notification, the processor 401 can be configured to return to step (220) and continue to work according to the algorithm described above.

The second stage 200 hence terminates as does the present method of detecting the reputation attacks.

### Computing Environment

With reference to FIG. 4, there is depicted an example functional diagram of the computing device 400 configurable to implement certain non-limiting embodiments of the present technology including the first stage 100 and the second stage 200 of the present method of detecting the reputation attacks.

In some non-limiting embodiments of the present technology, the computing device 400 may include: the processor 401 comprising one or more central processing units (CPUs), at least one non-transitory computer-readable memory 402 (RAM), a storage 403, input/output interfaces 404, input/output means 405, data communication means 406.

According to some non-limiting embodiments of the present technology, the processor 401 may be configured to execute specific program instructions the computations as required for the computing device 400 to function properly or to ensure the functioning of one or more of its components. The processor 401 may further be configured to execute specific machine-readable instructions stored in the at least one non-transitory computer-readable memory 402, for example, those causing the computing device 400 to execute one of the first method 100, the second method 200, and the third method 300.

In some non-limiting embodiments of the present technology, the machine-readable instructions representative of software components of disclosed systems may be implemented using any programming language or scripts, such as C, C++, C#, Java, JavaScript, VBScript, Macromedia Cold Fusion, COBOL, Microsoft Active Server Pages, Assembly, Perl, PHP, AWK, Python, Visual Basic, SQL Stored Procedures, PL/SQL, any UNIX shell scrips or XML. Various algorithms are implemented with any combination of the data structures, objects, processes, procedures and other software elements.

The at least one non-transitory computer-readable memory 402 may be implemented as RAM and contains the necessary program logic to provide the requisite functionality.

The storage 403 may be implemented as at least one of an HDD drive, an SSD drive, a RAID array, a network storage, a flash memory, an optical drive (such as CD, DVD, MD, Blu-ray), etc. The storage 403 may be configured for long-term storage of various data, e.g., the aforementioned documents with user data sets, databases with the time intervals measured for each user, user IDs, etc.

The input/output interfaces 404 may comprise various interfaces, such as at least one of USB, RS232, RJ45, LPT, COM, HDMI, PS/2, Lightning, FireWire, etc.

The input/output means 405 may include at least one of a keyboard, a joystick, a (touchscreen) display, a projector, a touchpad, a mouse, a trackball, a stylus, speakers, a microphone, and the like. A communication link between each one of the input/output means 405 can be wired (for example, connecting the keyboard via a PS/2 or USB port on the chassis of the desktop PC) or wireless (for example, via a wireless link, e.g., radio link, to the base station which is directly connected to the PC, e.g., to a USB port).

The data communication means 406 may be selected based on a particular implementation of a network, to which the computing device 400 can have access, and may comprise at least one of: an Ethernet card, a WLAN/Wi-Fi adapter, a Bluetooth adapter, a BLE adapter, an NFC adapter, an IrDa, a RFID adapter, a GSM modem, and the like. As such, the connectivity hardware 404 may be configured for wired and wireless data transmission, via one of a WAN, a PAN, a LAN, an Intranet, the Internet, a WLAN, a WMAN, or a GSM network, as an example.

These and other components of the computing device 500 may be linked together using a common data bus 410.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for detecting reputation cyberattacks in a network, the method being executable by a computing device including a processor communicatively coupled to the network, the method comprising:
during a first phase:
crawling, by the processor, the network to identify a plurality of publication sources;
identifying, in the plurality of publication sources, suspicious publication sources having been used for posting suspicious publications, the suspicious publications for executing reputation cyberattacks in the network;
identifying, by the processor, in each of the suspicious publication sources, suspicious user accounts having posted the suspicious publications;
determining, by the processor, among the suspicious user accounts, bot user accounts; and
storing, by the processor, data of the suspicious publication sources and that of the bot user accounts having posted the suspicious publications thereon in a database;
during a second phase following the first phase:
obtaining, by the processor, at least one word representing an object of a potential reputation cyberattack;
crawling, by the processor, the network to identify in-use publications including the at least one word associated with the object of the potential reputation attack;
determining, by the processor, based on the data in the database, in-use statistics associated with the in-use publications,
the in-use statistics being indicative of at least one of: (i) quantitative characteristics associated with the in-use publications and (ii) how the quantitative characteristics change over time;
in response to at least one of the in-use statistics exceeding a respective predetermined threshold value, determining, by the processor, (i) a given reputation attack targeting the object; and (ii) a respective type of the given reputation attack; and
generating, by the processor, a notification of the given reputation attack including the respective type thereof for transmission of the notification to an entity associated with the object.

2. The method of claim 1, wherein the suspicious publication sources include at least one of:
compromising material aggregators,
social networks,
data leak aggregators,
advertising platforms,
groups of related sources,
user feedback aggregators, and
sites for hiring remote workers.

3. The method of claim 2, wherein the groups of related sources include publication sources that have identical publications,
the identical publications having been posted more than a threshold number of times, with a
publication time difference therebetween not exceeding a threshold time difference value.

4. The method of claim 1, wherein the bot user accounts include user accounts that make at least a predetermined number of publications within a predetermined period.

5. The method of claim 4, wherein the bot user accounts further include the user accounts that make publications with a frequency exceeding a threshold frequency value over the predetermined period.

6. The method of claim 1, wherein the quantitative characteristics associated with the in-use publications include at least one of:
a total number of the in-use publications,
a number of in-use publications posted by the bot user accounts,
a number of in-use publications made on compromising material aggregators,
a number of in-use publications made by groups of related publication sources,
a number of in-use publications made by suspicious publication sources that are classified as being both groups of related sources and compromising material aggregators,
a number of in-use publications made on advertising platforms,
a number of in-use publications made on advertising platforms that form part of at least one group of related sources,
a number of in-use publications made on user feedback aggregators,
a number of in-use publications made on data leak aggregators,
a number of in-use publications made on web resources for hiring remote workers,
a total number of in-use publications duplicating each other,
a total number of in-use publications on compromising material aggregators duplicating each other,
a total number of in-use publications on compromising material aggregators duplicating each other and made by the bot user accounts,
a respective total number of hyperlinks in a given in-use publication,
a respective total number of hyperlinks in a given in-use publications that has duplicates,
a number of user accounts from which in-use publications have been posted,
a number of the bot user accounts from which the in-use publications have been posted,
a number of user accounts from which in-use publications have been posted on the compromising material aggregators, and
a number of user accounts, controlled by bots, from which the publications are posted on compromising material aggregators, and
number of accounts from which the publications identified on advertising platforms are posted.

7. The method of claim 1, wherein the in-use statistics further include dynamic changes thereof at a plurality of predetermined moments in time over a predetermined time interval.

8. The method of claim 1, wherein, for the at least one in-use statistic, the respective predetermined threshold is expressed in at least one of absolute and relative units.

9. The method of claim 1, wherein the transmission of the notification to the entity associated with the object is executed by at least one of:
an e-mail,
an SMS,
an MMS,
push notifications,
instant messenger messages, and
API events.

10. The method of claim 1, wherein the respective type of the given reputation attack is assigned with a numerical value indicative of a severity level of the given reputation attack.

11. The method of claim 1, wherein the severity level includes at least one of “Warning”, “Threat”, and “Attack”.

12. A system for detecting reputation cyberattacks in a network, the system comprising a computing device including (i) a processor communicatively coupled to the network, and (ii) a non-transitory computer-readable memory storing instructions, the processor, upon executing the instructions, being configured to:
during a first phase:
crawl the network to identify a plurality of publication sources;
identify, in the plurality of publication sources, suspicious publication sources having been used for posting suspicious publications, the suspicious publications for executing reputation cyberattacks in the network;
identify, in each of the suspicious publication sources, suspicious user accounts having posted the suspicious publications;
determine, among the suspicious user accounts, bot user accounts; and
store data of the suspicious publication sources and that of the bot user accounts having posted the suspicious publications thereon in a database;
during a second phase following the first phase:
obtain at least one word representing an object of a potential reputation cyberattack;
crawl the network to identify in-use publications including the at least one word associated with the object of the potential reputation attack;
determine, based on the data in the database, in-use statistics associated with the in-use publications,
the in-use statistics being indicative of at least one of: (i) quantitative characteristics associated with the in-use publications and (ii) how the quantitative characteristics change over time;
in response to at least one of the in-use statistics exceeding a respective predetermined threshold value, determine (i) a given reputation attack targeting the object; and (ii) a respective type of the given reputation attack; and
generate a notification of the given reputation attack including the respective type thereof for transmission of the notification to an entity associated with the object.
